(19) United States
(12) Patent Application Publication
(10) Pub. No.: US 2021/0309347 A1
(43) Pub. Date: Oct. 7, 2021

(54) PROPELLER STRUCTURE IN THE FORM OF TWIN MOBIUS BLADES FOR AIRCRAFT

(71) Applicant: Kwang Moo LEE, Seoul (KR)

(72) Inventor: Kwang Moo LEE, Seoul (KR)

(21) Appl. No.: 17/178,572

(22) Filed: Feb. 18, 2021

(30) Foreign Application Priority Data
Apr. 1, 2020 (KR) 10-2020-0039661

(51) Int. Cl. B64C 11/00; B64D 27/24; B64C 11/48

(52) U.S. Cl. CPC B64C 11/005; B64C 11/48; B64D 27/24

(57) ABSTRACT

A propeller structure in the form of twin Mobius blades for an aircraft is provided in which it is possible to easily control flight speed and posture by free movement and interlocking movement through supersymmetrical twisting, it is possible to selectively individually control the left and right propeller blades by rotating and operating the left and right propeller blades of an aircraft body in a spur gear scheme through one drive shaft connected by first to third motors and fourth to sixth motors, respectively, it is possible to enhance the propulsion and control each blade by forming a propeller with a structure a plurality of pairs of blades on both sides of the aircraft body, and it is easy to control the direction by rotating and operating the blades by a tilting scheme of a toothed gear through a drive shaft connected to a tail blade of the aircraft body by a seventh motor.

### CROSS-REFERENCE TO RELATED APPLICATION(S)

This application claims priority to Korean Patent Application No. 10-2020-0039661 filed on Apr. 1, 2020 in the Korean Intellectual Property Office, the disclosure of which is incorporated herein by reference.

### BACKGROUND OF THE INVENTION

### 1. Field of the Invention

The present invention relates to a propeller structure in the form of twin Mobius blades for an aircraft in which unlike the conventional propeller blade which is a symmetrical balance body, by forming a propeller in the form of twin Mobius blades, it is possible to easily control flight speed and posture by free movement and interlocking movement through supersymmetrical twisting, by rotating and operating left propeller blades and right propeller blades of an aircraft body in a spur gear scheme through one drive shaft connected by first to third motors and fourth to sixth motors, respectively, it is possible to selectively individually control the left and right propeller blades, and control propulsion and lift with inner and central parts of the twin Mobius blades and control a direction and radiate side thrust with outer parts, unlike a case where in the case of general propeller blades, it is more difficult to climb with the force of the wind from the ground and it is difficult to maintain regular movement in spite of climbing, by forming the propeller in the form of the twin Mobius blades, wind power is circulated with a multi-layered multi-angle structure to easily control a net function of the wind power, rather than flying with a conventional structure of single a pair of propeller, by forming a propeller with a structure a plurality of pairs of blades on both sides of the aircraft body, it is possible to enhance the propulsion and control each blade, and drop control is possible with buoyancy and lift of the blades, and as a result, there is no drop risk even though some blades do not operate, and by rotating and operating the blades by a tilting scheme of a toothed gear through a drive shaft connected to a tail blade of the aircraft body by a seventh motor, it is easy to control the direction.

### 2. Description of Related Art

An aircraft flying with lift generated by rotating a rotor with an engine is called a helicopter.

The helicopter includes general helicopters on which people can get and drones, which are relatively small helicopters that fly without people. The drone refers to an unmanned aerial vehicle that can be controlled remotely using radio waves without a pilot on board. Unlike the general aircraft, since the drone does not separately have a space and a safety device for the pilot, the drone can be miniaturized and lightweight and used for reconnaissance for information collection or reconnaissance in places where people access is difficult or for industrial use for various purposes and in particular, in recent years, as small-sized drones are supplied, the drones are used even as hobby tools for general persons.

In recent years, with the development of wireless communication and mobile terminals, a number of technologies using a combination of the drone and the mobile terminal have been developed. For example, there are functions such as data and voice communication, photographing and video shooting through a camera, and voice recording. An electronic game play function is added or some terminals or some terminals serve as a multimedia player function.

As the functions of such drones are diversified, the drones are implemented in the form of a multimedia player having complex functions such as taking photos or videos, receiving broadcasts, etc.

In particular, when the camera is mounted on the drone, the drone can perform more functions. The drone on which the camera is mounted can be used not only for reconnaissance but also lifesaving.

However, in a typical drone, through a plurality of propellants provided with a main body constituting the skeleton of the aircraft, a propellant support frame protruding radially from the main body, and a motor that is directly connected to the propellant support frame and rotates the propeller at high speed, the body is propelled to fly.

The propellants constituted by the propeller and the motor rotating the propeller at high speed are generally provided in plural at the outermost part of the drone body, and as a result, a propellant motor is damaged due to collision with other unmanned aerial vehicles and external obstacles or the propeller which rotates at high speed is damaged and scattered, and as a result, there is a problem that a problem of a safety accident will occur and when the drone is moved forward, backward, or sideways, the drone is moved while the drone body is inclined to the front, the rear, or the side, and as a result, the drone cannot be moved while the drone body is kept horizontally.

In addition, the existing drones are convenient to control with the support of electronic equipment and fly with the power of batteries and electric motors, so the existing drones are convenient systems for expanding functions, but have a disadvantage of short flight time.

In particular, when taking off or landing vertically, the battery consumption is fast and the life of the motor and propeller is shortened because almost all the energy output for the flight of the aircraft is required and a vehicle driven by an engine has a disadvantage that noise and vibration are large and precise control is more difficult than a motor.

The development of a propeller structure in the form of twin Mobius blades for an aircraft is urgently required, in which by forming a propeller in the form of twin Mobius blades, it is possible to easily control flight speed and posture by free movement and interlocking movement through supersymmetrical twisting, by rotating and operating left propeller blades and right propeller blades of an aircraft body in a spur gear scheme through one drive shaft connected by first to third motors and fourth to sixth motors, respectively, it is possible to selectively individually control the left and right propeller blades, by forming the propeller in the form of the twin Mobius blades, wind power is circulated with a multi-layered multi-angle structure to easily control a net function of the wind power, and by forming a propeller with a structure a plurality of pairs of blades on both sides of the aircraft body, it is possible to enhance the propulsion and control each blade, and drop control is possible with buoyancy and lift of the blades, and as a result, there is no drop risk even though some blades do not operate, and by rotating and operating the blades by a tilting scheme of a toothed gear through a drive shaft connected to a tail blade of the aircraft body by a seventh motor, it is easy to control the direction.

### SUMMARY OF THE INVENTION

Accordingly, the present invention is contrived to solve the problems and the present invention has been made in an effort to provide a propeller structure in the form of twin Mobius blades for an aircraft in which unlike the conventional propeller blade which is a symmetrical balance body, by forming a propeller in the form of twin Mobius blades, it is possible to easily control flight speed and posture by free movement and interlocking movement through supersymmetrical twisting.

The present invention has also been made in an effort to provide a propeller structure in the form of twin Mobius blades for an aircraft in which by rotating and operating left propeller blades and right propeller blades of an aircraft body in a spur gear scheme through one drive shaft connected by first to third motors and fourth to sixth motors, respectively, it is possible to selectively individually control the left and right propeller blades.

The present invention has also been made in an effort to provide a propeller structure in the form of twin Mobius blades for an aircraft in which it is possible to control propulsion and lift with inner and central parts of the twin Mobius blades and control a direction and radiate side thrust with outer parts.

The present invention has also been made in an effort to provide a propeller structure in the form of twin Mobius blades for an aircraft in which unlike a case where in the case of general propeller blades, it is more difficult to climb with the force of the wind from the ground and it is difficult to maintain regular movement in spite of climbing, by forming the propeller in the form of the twin Mobius blades, wind power is circulated with a multi-layered multi-angle structure to easily control a net function of the wind power.

The present invention has also been made in an effort to provide a propeller structure in the form of twin Mobius blades for an aircraft in which rather than flying with a conventional structure of single a pair of propeller, by forming a propeller with a structure a plurality of pairs of blades on both sides of the aircraft body, it is possible to enhance the propulsion and control each blade, and drop control is possible with buoyancy and lift of the blades, and as a result, there is no drop risk even though some blades do not operate.

The present invention has also been made in an effort to provide a propeller structure in the form of twin Mobius blades for an aircraft in which by rotating and operating the blades by a tilting scheme of a toothed gear through a drive shaft connected to a tail blade of the aircraft body by a seventh motor, it is easy to control the direction.

The present invention has also been made in an effort to provide a propeller structure in the form of twin Mobius blades for an aircraft in which by mounting a wireless module, acquired information is transmitted to an information center server to collect information on places where access is difficult for people, to reconnaissance to special places, and to guide outbreaks of forest fires.

In order to achieve the objects, an exemplary embodiment of the present invention provides a propeller structure in the form of twin Mobius blades for an aircraft, including: a plurality of body left side blades coupled and mounted onto a body part and a tail part of an aircraft or an aerial vehicle including a head part, the body part, and the tail part, having a Mobius strip shape of being fastened and fixed to a left side of the body part of the aircraft or the aerial vehicle, and formed as a cylindrical part so that one side is inserted and fixed into a gear shaft; a plurality of body right side blades having a Mobius strip shape of being fastened and fixed to a right side of the body part of the aircraft or the aerial vehicle and formed in a cylindrical part so that one side is inserted and fixed into the gear shaft; a plurality of tail side blades having a Mobius strip shape of being fastened and fixed to the tail part of the aircraft or the aerial vehicle and formed in a cylindrical part so that one of both sides is inserted and fixed into the gear shaft; a gear part case allowing the cylindrical parts formed at one side of each of the body left side blades, the body right side blades, and the tail side blades to be inserted into a hole formed to face the surface of the case and including a gear part case coupling member; gears mounted inside the gear part case and allowing the body left side blades, the body right side blades, and the tail side blades to be rotated by driving of a motor receiving power; a driving device (motor) allowing the gears to be rotated at a controlled speed; a fuel cell pack supplying power so as to operate the driving device (motor); and a control unit controlling rotational speeds of the body left side blades, the body right side blades, and the tail side blades.

In the present invention, the body left side blades and the body right side blades may be driven while being connected by first to third motors and fourth to sixth motors through gears, and the tail side blades may be driven while being connected by a seventh motor through the gear.

In the present invention, the gears that allow the body left side blades and the body right side blades to be rotated by driving of the motor receiving the power supply may be the type of spur gear and as the gears that allow the tail side blades to be rotated by driving of the motor receiving the power supply, any one of a helical gear, a bevel gear, a spiral bevel gear, a worm gear, and a hypoid gear the gears may be selected and applied.

In the present invention, the fuel cell pack may be replaced with a lithium battery pack to be applied.

In the present invention, front parts and rear parts of the body left side blades, the body right side blades, and the tail side blades may have a streamlined shape, front lateral parts of the blades may be twisted once and rear lateral parts may be twisted twice, and a ratio of a twisting lengths of the rear lateral parts of the blades may be 1:2:2:1.

In the present invention, the propulsion and the lift may be controlled with the inner and central parts of the body left side blades, the body right side blades, and the tail side blades, and the direction may be controlled and the side thrust may be radiated with the outer parts of the blades, and the inner parts of the blades may be divided into both sides of central part with a width of 1.3 compared to 1 in length.

In the present invention, the surface of the case of the control unit may be coated with a conductive polymer made of polyaniline or polypyrrole to prevent malfunction of the control unit due to disturbance from electromagnetic waves.

In the present invention, the propeller structure in the form of twin Mobius blades for an aircraft further include a wireless module applied for collecting information on places where access is difficult for people, for reconnaissance, and guiding forest fires, and transmitting acquired information to an information center server or a control center server.

As described above, the propeller structure in the form of twin Mobius blades for an aircraft of the present invention has the following effects.

First, according to the present invention, unlike the conventional propeller blade which is a symmetrical balance body, by forming a propeller in the form of twin Mobius blades, it is possible to easily control flight speed and posture by free movement and interlocking movement through supersymmetrical twisting.

Second, according to the present invention, by rotating and operating left propeller blades and right propeller blades of an aircraft body in a spur gear scheme through one drive shaft connected by first to third motors and fourth to sixth motors, respectively, it is possible to selectively individually control the left and right propeller blades.

Third, according to the present invention, it is possible to control propulsion and lift with inner and central parts of the twin Mobius blades and control a direction and radiate side thrust with outer parts.

Fourth, according to the present invention, unlike a case where in the case of general propeller blades, it is more difficult to climb with the force of the wind from the ground and it is difficult to maintain regular movement in spite of climbing, by forming the propeller in the form of the twin Mobius blades, wind power is circulated with a multi-layered multi-angle structure to easily control a net function of the wind power.

Fifth, according to the present invention, rather than flying with a conventional structure of single a pair of propeller, by forming a propeller with a structure a plurality of pairs of blades on both sides of the aircraft body, it is possible to enhance the propulsion and control each blade, and drop control is possible with buoyancy and lift of the blades, and as a result, there is no drop risk even though some blades do not operate.

Sixth, by rotating and operating the blades by a tilting scheme of a toothed gear through a drive shaft connected to a tail blade of the aircraft body by a seventh motor, it is easy to control the direction.

### BRIEF DESCRIPTION OF THE DRAWINGS

FIG. 1 is a diagram illustrating a shape of an aircraft or an aerial vehicle to which a propeller in the form of twin Mobius blades for an aircraft is attached according to an exemplary embodiment of the present invention.

FIG. 2 is a diagram illustrating a configuration of a propeller in the form of twin Mobius blades for an aircraft mounted on a body part of an aircraft or an aerial vehicle according to an exemplary embodiment of the present invention.

FIG. 3 is a diagram illustrating a configuration of a propeller in the form of twin Mobius blades for an aircraft mounted on a tail part of an aircraft or an aerial vehicle according to an exemplary embodiment of the present invention.

FIG. 4 is a diagram illustrating a ratio of a twisting length of a rear lateral surface of Mobius blades in a configuration of a propeller in the form of twin Mobius blades for an aircraft according to an exemplary embodiment of the present invention.

FIG. 5 is a diagram illustrating a shape in which twin Mobius blades are connected to a gear of a tail part in a configuration of a propeller in the form of twin Mobius blades for an aircraft according to an exemplary embodiment of the present invention.

### DETAILED DESCRIPTION OF THE PREFERRED EMBODIMENT

Hereinafter, an exemplary embodiment of the present invention will be described below together with the accompanying drawings, and when it is determined that a detailed description of a related known technology or configuration may unnecessarily obscure the subject matter of the present invention, the detailed Description will be omitted, and terms to be described later are terms defined in consideration of functions in the present invention and may vary according to intentions or customs of users and operators, so the definition should be made based on contents described throughout the present invention, which describe a propeller structure in the form of twin Mobius blades for an aircraft according to the present invention.

Hereinafter, a propeller structure in the form of twin Mobius blades for an aircraft according to an exemplary embodiment of the present invention will be described in detail with reference to the accompanying drawings.

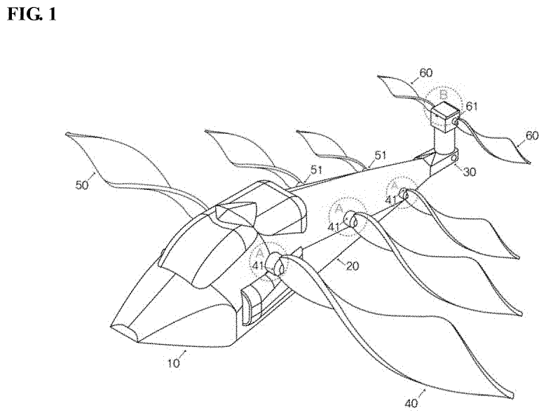

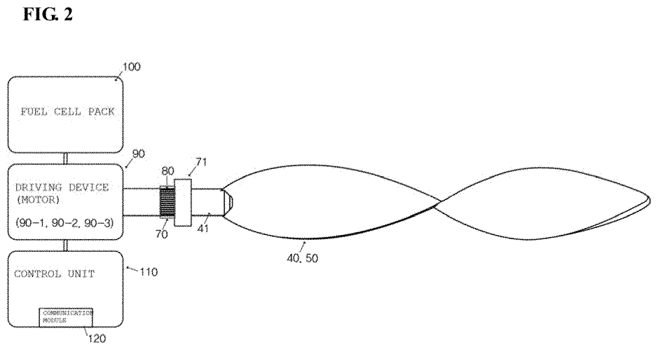

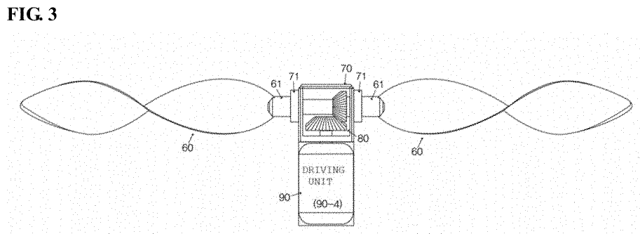

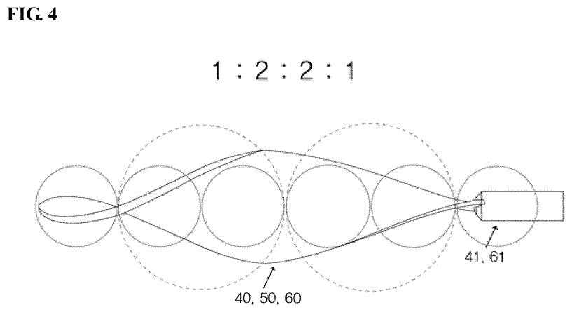

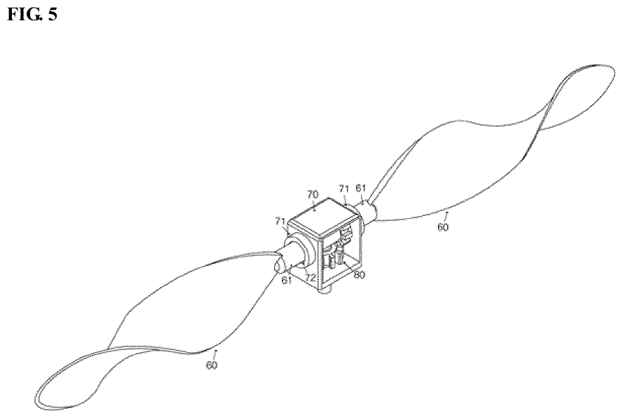

FIG. 1 is a diagram illustrating a shape of an aircraft or an aerial vehicle to which a propeller in the form of twin Mobius blades for an aircraft is attached according to an exemplary embodiment of the present invention, FIG. 2 is a diagram illustrating a configuration of a propeller in the form of twin Mobius blades for an aircraft mounted on a body part of an aircraft or an aerial vehicle according to an exemplary embodiment of the present invention, FIG. 3 is a diagram illustrating a configuration of a propeller in the form of twin Mobius blades for an aircraft mounted on a tail part of an aircraft or an aerial vehicle according to an exemplary embodiment of the present invention, FIG. 4 is a diagram illustrating a ratio of a twisting length of a rear lateral surface of Mobius blades in a configuration of a propeller in the form of twin Mobius blades for an aircraft according to an exemplary embodiment of the present invention, and FIG. 5 is a diagram illustrating a shape in which twin Mobius blades are connected to a gear of a tail part in a configuration of a propeller in the form of twin Mobius blades for an aircraft according to an exemplary embodiment of the present invention.

A propeller structure in the form of twin Mobius blades for an aircraft according to the present invention includes an aircraft or aerial vehicle head part 10, an aircraft or aerial vehicle body part 20, an aircraft or aerial vehicle tail part 30, a body left side blade 40, a cylindrical part 41, a body right side blade 50, a cylindrical part 51, a tail side blade 60, a cylindrical part 61, a gear part case 70, a gear part case coupling member 71, a gear part case surface hole 72, gears 80, a driving device (motor) 90, a fuel cell pack 100, a control unit 110, a wireless module, and the like.

As illustrated in FIGS. 1 to 5, the propeller structure in the form of twin Mobius blades for an aircraft according to the present invention includes a plurality of body left side blades 40 coupled and mounted onto a body part 20 and a tail part 30 of an aircraft or an aerial vehicle including a head part 10, the body part 20, and the tail part 30, having a Mobius strip shape of being fastened and fixed to a left side of the body part 20 of the aircraft or the aerial vehicle, and formed as a cylindrical part 41 so that one side is inserted and fixed into a gear shaft; a plurality of body right side blades 50 having a Mobius strip shape of being fastened and fixed to a right side of the body part 20 of the aircraft or the aerial vehicle and formed in a cylindrical part 51 so that one side is inserted and fixed into the gear shaft; a plurality of tail side blades 60 having a Mobius strip shape of being fastened and fixed to the tail part 30 of the aircraft or the aerial vehicle and formed in a cylindrical part 61 so that one of both sides is inserted and fixed into the gear shaft; a gear part case 70 allowing the cylindrical parts 41, 51, and 61 formed at one side of each of the body left side blades 40, the body right side blades 50, and the tail side blades 60 to be inserted into a hole 72 formed to face the surface of the case 70 and including a gear part case coupling member 71; gears 80 mounted inside the gear part case 70 and allowing the body left side blades 40, the body right side blades 50, and the tail side blades 60 to be rotated by driving of a motor 90 receiving power; a driving device (motor) 90 allowing the gears 80 to be rotated at a controlled speed; a fuel cell pack 100 supplying power so as to operate the driving device (motor) 90; and a control unit 110 controlling rotational speeds of the body left side blades 40, the body right side blades 50, and the tail side blades 60, and further includes a wireless module 120 applied for collecting information on places where access is difficult for people, for reconnaissance, and guiding forest fires, and transmitting acquired information to an information center server.

Functions of each technical means constituting an air motor according to the present invention are described as below.

The plurality of body left side blades 40 is coupled and mounted onto a body part 20 and a tail part 30 of an aircraft or an aerial vehicle including a head part 10, the body part 20, and the tail part 30, has a Mobius strip shape of being fastened and fixed to a left side of the body part 20 of the aircraft or the aerial vehicle, and is formed as a cylindrical part 41 so that one side is inserted and fixed into a gear shaft.

The plurality of body right side blades 50 has a Mobius strip shape of being fastened and fixed to a right side of the body part 20 of the aircraft or the aerial vehicle and is formed in a cylindrical part 51 so that one side is inserted and fixed into the gear shaft.

The body left side blades 40 and the body right side blades 50 are driven while being connected by first to third motors 90-1, 90-2, and 90-3 and fourth to sixth motors 90-4, 90-5, and 90-6 through gears.

The plurality of tail side blades 60 has a Mobius strip shape of being fastened and fixed to the tail part 30 of the aircraft or the aerial vehicle and is formed in a cylindrical part 61 so that one of both sides is inserted and fixed into the gear shaft.

Here, the tail side blades 60 are driven while being connected by a seventh motor 90-7 through the gear.

The Mobius strip described above has a shape like a phase space formed by twisting one half of a long and thin rectangular strip and then attaching the two ends. Specifically, the Mobius strip is a two-dimensional figure with only one boundary as a figure that has no distinction between inside and outside, that is, there is no distinction between inside and outside. When after making a strip by cutting the paper in length, the ends of the paper strip is just glued to form a donut-shaped torus, both ends are twisted once and attached to become the Mobius strip. If the Mobius strip moves along the center of the strip at a predetermined point, the opposite side may be reached from the starting point, and if the Mobius strip keeps going in this situation, the Mobius strip returns to its initial position by turning twice, and the Mobius strip has a single boundary due to such continuity.

As illustrated in FIG. 4, front parts and rear parts of the body left side blades 40, the body right side blades 50, and the tail side blades 60 have a streamlined shape, front lateral parts of the blades 40, 50, and 60 are twisted once and rear lateral parts are twisted twice, and a ratio of a twisting lengths of the rear lateral parts of the blades 40, 50, and 60 is 1:2:2:1.

The gear part case 70 allows the cylindrical parts 41, 51, and 61 formed at one side of each of the body left side blades 40, the body right side blades 50, and the tail side blades 60 to be inserted into a hole 72 formed to face the surface of the case 70.

The gears 80 is mounted inside the gear part case 70 and allows the body left side blades 40, the body right side blades 50, and the tail side blades 60 to be rotated by driving of a motor 90 receiving power.

Here, the gears 80 that allow the body left side blades 40 and the body right side blades 50 to be rotated by driving of the motor 90 receiving the power supply are the type of spur gear and as the gears 80 that allow the tail side blades 60 to be rotated by driving of the motor receiving the power supply, any one of a helical gear, a bevel gear, a spiral bevel gear, a worm gear, and a hypoid gear the gears 80 may be selected and applied, and a tilting scheme that controls the vehicle through vertical and horizontal movements is adopted.

The spur gear described above refers to a general spur gear that often comes to mind when it comes to a cogwheel and is the most used gear, and since the spur gear also has a simple overall structure, is easily manufactured and assembled, and has low total cost, and may be made flat and thin, so the spur gear may be commonly viewed by opening an analog watch.

Further, in the helical gear, the cogwheel itself is thick and the teeth are diagonal and in the general spur gear, when the teeth are engaged, a contact surface is small and all surfaces are attached at once, so the impact is large when the teeth are in contact with each other, but in the helical gear, since the teeth are diagonal, the gears are sequentially engaged and as the teeth rotate, the teeth are gradually in contact with each other, the impact is small and the teeth smoothly rotate, and the helical gear has a larger contact surface than the spur gear in which only one surface is engaged at once, so the helical gear is advantageous in power transfer, has more enhanced surface pressure durability than the spur gear, but since the helical gear is relatively difficult to manufacture, the helical gear has a higher unit price than the spur gear.

In addition, the bevel gear and the spiral bevel gear have a structure in which since the teeth are wrapped diagonally instead of the side of the gear, so that the teeth are vertically engaged with each other, and are used when changing a rotational direction of the shaft, and as a tooth shape, there is the spur gear and the helical gear is also often used, and it is possible to change the direction of the shaft and adjust a gear ratio.

Further, the worm gear is a gear constituted by the cogwheel on one side and a worm having a spiral like a bolt on the other side and unlike other gears, in the worm gear, the worm gear may transfer power only to the gear from the worm and not transfer the power in an opposite direction in terms of a structure, and may have a higher gear ratio than other gears.

Further, the hypoid gear has a similar shape to the spiral bevel gear, a pinion shaft is offset from the center of a gear shaft, and engagement thereof is a form in which slip in this direction is added to a rolling action of the bevel gear, so the hypoid gear may rotate more silent and smooth than the spiral bevel gear and have the high gear ratio, but the hypoid gear is difficult to manufacture, so the hypoid gear is high in unit price.

The driving device (motor) 90 allows the gears 80 to be rotated at a controlled speed.

The fuel cell pack 100 supplies power so as to operate the driving device (motor) 90.

Here, the fuel cell pack 100 is replaced with a lithium battery pack to be applied and a lithium iron phosphate battery back will also be possible.

A fuel cell of the fuel cell pack 100 is a future power source that generates electricity by chemically reacting hydrogen with oxygen in the air, and when water is electrolyzed, the water is decomposed into hydrogen and oxygen. On the contrary, hydrogen and oxygen are combined to make water, and a principle is used, in which energy generated at this time may be converted into electricity. The composition of a fuel cell is constituted by two electrodes attached to each other around an electrolytic material, and a principle thereof is that when oxygen in the air passes through one electrode and hydrogen passes through the other electrode, electricity, water, and heat are generated through an electrochemical reaction. The fuel cell is similar to the battery in that electricity is generated by a chemical reaction, but the fuel cell receive hydrogen and oxygen which are reactive materials, and as a result, the fuel cell need not be charged unlike the battery and generates electricity as long as fuel is supplied.

Further, since energy is generated without a combustion reaction of fuel, the fuel cell is eco-friendly because the fuel cell does not discharge toxic pollutants such as sulfur and nitrogen oxides and may significantly reduce carbon dioxide emissions unlike conventional internal combustion engines. Since the fuel cell does not have a separate driving unit, there is no noise, and energy efficiency is 50% compared to other energy sources, which is higher than 30% of the internal combustion engines. Unlike a primary battery that is used and discarded once or a rechargeable battery which is rechargeable several times, the fuel cell is a low-emission high-efficiency next-generation energy source which may be permanently used as long as a fuel cartridge is continuously replaced without separate power charging.

The control unit 110 controls rotational speeds of the body left side blades 40, the body right side blades 50, and the tail side blades 60.

Here, the surface of the case of the control unit 110 is coated with a conductive polymer made of polyaniline or polypyrrole to prevent malfunction of the control unit 110 due to disturbance from electromagnetic waves.

The conductive polymer literally refers to a polymer through which electricity may flow, and structures of most conductive polymers have features of alternatively having a single bond and a double bon, and the use of the conductive polymer includes removal of static electricity, and shielding and absorbance of harmful electromagnetic waves. The greatest advantage of the conductive polymer is that processability is very diversified, and the conductive polymer is lightweight, can be mass-produced, and is earth free. The cause of the static electricity is that static charges are concentrated at the edge of a charged material, resulting in high voltage, and the conductive polymer, and the conductive polymer prevents the static electricity from being concentrated on one portion and dissipates the static electricity in another energy form.

The wireless module 120 is applied for collecting information on places where access is difficult for people, for reconnaissance, and guiding forest fires, and transmitting acquired information to an information center server or a control center server (not illustrated).

As described above, the propulsion and the lift are controlled with the inner and central parts of the body left side blades 40, the body right side blades 50, and the tail side blades 60, and the direction is controlled and the side thrust is radiated with the outer parts of the blades 40, 50, and 60, and the inner parts of the blades 40, 50, and 60 are divided into both sides of central part with a width of 1.3 compared to 1 in length.

When the propeller in the form of the Mobius blades according to the present invention and the general propeller are compared with each other, the general propeller performs horizontal movement (rod movement), whereas the propeller in the form of the Mobius blades performs vertical circular movement (wave movement) and the general propeller performs linear movement, asymmetric movement, simple movement, and ordinary movement, whereas the propeller in the form of the Mobius blades performs curved movement, symmetric movement (supersymmetric movement), combined movement, and latent movement.

As described above, since the propeller structure in the form of the twin Mobius blades for the aircraft may be applied to the field of unmanned aerial vehicles for reconnaissance, guidance drones depending on transmission of information on disasters or fires, and forest fires, and micro-aircraft fields, the use and an application target of the propeller structure are broad.

Although an optimal exemplary embodiment is disclosed in the drawings and the specification, and terms used herein are used only for the purpose of describing the present invention and are not used to restrict meanings or limit the scope of the present invention defined in the claims. Therefore, those skilled in the art will be able to make various modifications and other equivalent exemplary embodiments therefrom, and thus, the true technical scope of the present invention should be determined by the technical spirit of the appended claims.

What is claimed is:

1. A propeller structure in the form of twin Mobius blades for an aircraft, comprising:
a plurality of body left side blades coupled and mounted onto a body part and a tail part of an aircraft or an aerial vehicle including a head part, the body part, and the tail part, having a Mobius strip shape of being fastened and fixed to a left side of the body part of the aircraft or the aerial vehicle, and formed as a cylindrical part so that one side is inserted and fixed into a gear shaft;
a plurality of body right side blades having a Mobius strip shape of being fastened and fixed to a right side of the body part of the aircraft or the aerial vehicle and formed in a cylindrical part so that one side is inserted and fixed into the gear shaft;
a plurality of tail side blades having a Mobius strip shape of being fastened and fixed to the tail part of the aircraft or the aerial vehicle and formed in a cylindrical part so that one of both sides is inserted and fixed into the gear shaft;
a gear part case allowing the cylindrical parts formed at one side of each of the body left side blades, the body right side blades, and the tail side blades to be inserted into a hole formed to face the surface of the case and including a gear part case coupling member;
gears mounted inside the gear part case and allowing the body left side blades, the body right side blades, and the tail side blades to be rotated by driving of a motor receiving power;
a driving device (motor) allowing the gears to be rotated at a controlled speed;
a fuel cell pack supplying power so as to operate the driving device (motor); and
a control unit controlling rotational speeds of the body left side blades, the body right side blades, and the tail side blades.

2. The propeller structure of claim 1, wherein the body left side blades and the body right side blades are driven while being connected by first to third motors and fourth to sixth motors through gears, and the tail side blades are driven while being connected by a seventh motor through the gear.

3. The propeller structure of claim 1, wherein the gears that allow the body left side blades and the body right side blades to be rotated by driving of the motor receiving the power supply are the type of spur gear and as the gears that allow the tail side blades to be rotated by driving of the motor receiving the power supply, any one of a helical gear, a bevel gear, a spiral bevel gear, a worm gear, and a hypoid gear the gears may be selected and applied.

4. The propeller structure of claim 1, wherein the fuel cell pack is replaced with a lithium battery pack to be applied.

5. The propeller structure of claim 1, wherein front parts and rear parts of the body left side blades, the body right side blades, and the tail side blades have a streamlined shape, front lateral parts of the blades are twisted once and rear lateral parts are twisted twice, and a ratio of a twisting lengths of the rear lateral parts of the blades is 1:2:2:1.

6. The propeller structure of claim 1, wherein the propulsion and the lift are controlled with the inner and central parts of the body left side blades, the body right side blades, and the tail side blades, and the direction is controlled and the side thrust is radiated with the outer parts of the blades, and the inner parts of the blades are divided into both sides of central part with a width of 1.3 compared to 1 in length.

7. The propeller structure of claim 1, wherein the surface of the case of the control unit is coated with a conductive polymer made of polyaniline or polypyrrole to prevent malfunction of the control unit due to disturbance from electromagnetic waves.

8. The propeller structure of claim 1, further comprising:
a wireless module applied for collecting information on places where access is difficult for people, for reconnaissance, and guiding forest fires, and transmitting acquired information to an information center server or a control center server.
